(19) United States
(12) Patent Application Publication
(10) Pub. No.: US 2026/0253376 A1
(43) Pub. Date: Aug. 27, 2026

(54) PATCHWISE MULTI-SCALE SIMILARITY ANALYSIS FOR BUILT-ENVIRONMENT STRUCTURE IMAGE LOOKUP ACROSS VARIOUS GEOGRAPHIC SCALES

(71) Applicant: Kevin Ramesh Kabaria, Richlands, VA (US)

(72) Inventor: Kevin Ramesh Kabaria, Richlands, VA (US)

(21) Appl. No.: 19/547,372

(22) Filed: Feb. 23, 2026

Related U.S. Application Data
(60) Provisional application No. 63/762,071, filed on Feb. 23, 2025.

(51) Int. Cl. G06V 10/74; G06N 3/0464; G06T 3/4053; G06T 5/70; G06T 7/11; G06V 10/762

(52) U.S. Cl. CPC G06V 10/761; G06N 3/0464; G06T 3/4053; G06T 5/70; G06T 7/11; G06V 10/762

(57) ABSTRACT

A system and method for analyzing images of built-environment structures at multiple geographic scales using patchwise segmentation and domain-specific embedding. The system extracts image patches at a plurality of spatial scales from imagery, generates patch embeddings via a neural network trained using semi-supervised or unsupervised learning on built-environment structure images, receives a query comprising an example image or textual descriptor, computes similarity scores between query and patch embeddings using a configurable metric, and aggregates scores across scales to produce a composite similarity result. The system supports configurable weighting of scale contributions, overlapping patches for boundary fidelity, hierarchical resolution processing for bandwidth efficiency, feedback-driven model refinement, and deployment across cloud, edge, and hybrid configurations. Applications include material identification, condition assessment, damage detection, and regional trend analysis for roofing and other built-environment structures.

### CROSS-REFERENCE TO RELATED APPLICATIONS

This application claims the benefit of U.S. Provisional Application No. 63/762,071, filed Feb. 23, 2025, the entire contents of which are hereby incorporated by reference.

### FIELD OF THE INVENTION

The present invention relates generally to computer-implemented image analysis systems and methods, and more specifically to systems and methods for analyzing images depicting built-environment structures at multiple geographic scales using patchwise segmentation, domain-specific embeddings trained via semi-supervised or unsupervised learning, and multi-scale similarity computation and aggregation.

### BACKGROUND OF THE INVENTION

Analyzing and classifying built-environment structures from aerial, satellite, drone, or ground-level imagery presents significant technical challenges. Such structures, including rooftops, exterior wall surfaces, paving, and related elements, exhibit visual characteristics that vary with geographic region, climate exposure, age, construction method, and imaging conditions. Identifying material composition, condition, structural style, or damage state from imagery has applications in maintenance planning, insurance assessment, materials tracking, and regional infrastructure analysis.

Conventional approaches often operate at a single spatial scale. Close-up approaches may capture fine texture and localized damage details, but can miss broader context such as overall structure geometry and neighborhood layout. Wide-area approaches may capture context, but can lose fine-grained signals needed to distinguish between similar materials or subtle damage patterns. Single-scale processing thus forces practitioners to choose between contextual breadth and localized fidelity, without a unified mechanism for balancing both.

Some conventional systems employ fixed-size sliding windows or uniform patch grids to process large images. While such approaches can partition an image into regions, they typically operate at a single spatial resolution and do not adapt the patch scale to the content or task. In particular, uniform patching applies the same window size everywhere, without distinguishing between regions where broad contextual information is most informative and regions where fine-grained localized detail is most informative. Such approaches also generally lack a mechanism for weighting or aggregating similarity contributions from different spatial scales into a unified result. Additionally, sliding window approaches that employ generic feature extractors do not tailor the feature space to the domain-specific attributes that distinguish built-environment materials, conditions, and structural characteristics from one another. It will be appreciated by those skilled in the art that applying a conventional convolutional neural network or other image classification model to a whole image or to uniformly sized patches does not, by itself, address the challenge of simultaneously capturing both broad contextual geometry and fine localized texture in a manner that can be differentially weighted and aggregated per query. The technical limitation is not in the feature extraction capability of any particular neural architecture, but rather in the system-level design: how imagery is partitioned into purposefully scaled patches, how the resulting embeddings are organized across scales, and how similarity contributions from those scales are combined into a unified result. A conventional image classifier operating on a single scale, regardless of the underlying neural architecture, does not produce the multi-resolution embedding structure necessary for cross-scale aggregation.

Many existing image analysis systems rely on generic image embeddings trained on broad collections of natural images or web-sourced content. While such embeddings capture general visual features, they may not encode, with sufficient fidelity, the structural and material attributes that are salient in the built-environment domain. For example, generic embeddings may emphasize aesthetic features such as color composition and scene layout rather than domain-relevant attributes such as material texture, granule distribution, or surface degradation patterns. The resulting representations may be insufficient for distinguishing between visually similar but materially distinct built-environment surfaces. A general-purpose embedding model, even when applied in a multi-scale pipeline, encodes feature spaces that were optimized for a different distribution of visual content and a different set of downstream tasks, and accordingly may conflate surface characteristics that are materially distinct in the built-environment domain while separating characteristics that are materially equivalent.

Large general-purpose vision-language or foundation models present additional challenges. Such models can impose substantial computational cost and deployment complexity when applied at geographic scales involving large numbers of structures. Distilling these models for deployment on resource-constrained devices can further degrade performance in the specific domain of built-environment analysis, because the distillation process may not preserve the domain-relevant features that were only weakly encoded in the general-purpose model to begin with. In addition, the training data and objectives of such models are not tailored to the structural and material attributes that differentiate built-environment surfaces, and the resulting feature spaces may conflate visually similar structures that are materially distinct. Because these general-purpose models were trained on a fundamentally different objective, the underlying knowledge they encode is not robust to the domain-specific distinctions that matter for built-environment analysis; for instance, two roofing surfaces may appear similar in an aesthetic or scene-level sense while differing meaningfully in material composition, degradation state, or compliance characteristics. A purpose-trained domain-specific model, by contrast, can achieve a level of fidelity on domain-relevant distinctions that a general-purpose model of comparable or even larger size cannot match, owing to the concentration of representational capacity on the target domain rather than across the breadth of all visual content.

Fully supervised learning approaches often require extensive labeled datasets with ground-truth annotations for material types, condition levels, or damage categories. Obtaining dense labels at the scale needed to cover diverse geographies and structure varieties can be prohibitively expensive and time-consuming. Further, fixed label sets may fail to generalize to new or rare structure types, materials, or degradation patterns.

The volume of imagery involved in regional-scale analysis compounds these issues. For example, a region-wide scan can involve processing imagery depicting large numbers of structures and may require multiple resolutions for different tasks. Processing all imagery at maximum resolution can impose high bandwidth and compute requirements, and conventional systems may lack efficient mechanisms to allocate higher-resolution processing to the regions most likely to contain structures of interest.

Additionally, it is desirable to support user queries expressed in multiple modalities. For example, a user may possess an example image patch of a target material or damage pattern, or may describe a target in natural language. Conventional systems often support only one query modality or provide limited mechanisms for balancing the contribution of broad context and fine texture in a single query.

Accordingly, there exists a need in the art for systems and methods that flexibly segment imagery into patches at multiple spatial scales, generate domain-focused embeddings using training strategies that do not require exhaustive labeling, support similarity-based lookups across scales, and operate efficiently across geographic scopes ranging from single structures to entire regions.

### SUMMARY OF THE INVENTION

In accordance with various embodiments of the present invention, systems and methods are provided for analyzing images of built-environment structures at multiple geographic scales using patchwise segmentation, domain-specific embedding, and multi-scale similarity computation and aggregation.

According to one embodiment, a system for image-based analysis of built-environment structures comprises at least one processor and at least one memory storing instructions that, when executed, cause the system to receive one or more images depicting a geographic region containing one or more built-environment structures; extract, from the one or more images, a plurality of image patches at a plurality of spatial scales; generate, for each image patch, a respective patch embedding via a domain-specific embedding model trained using at least one of semi-supervised learning or unsupervised learning on training images of built-environment structures; receive a query and generate a corresponding query embedding in a shared embedding space; compute similarity scores between patch embeddings and the query embedding using a similarity metric; and aggregate the similarity scores across the plurality of spatial scales to produce a composite similarity result.

In some embodiments, a first spatial scale captures contextual features such as overall structure geometry, roof shape, and spatial arrangement relative to surrounding structures, while a second spatial scale captures localized surface features such as material texture, component-level detail, and localized condition or damage patterns. Training with patches extracted at varied spatial scales encourages the embedding model to learn scale-dependent representations, so that coarse patches emphasize structural geometry and layout while fine patches emphasize localized texture and material composition.

In certain embodiments, the domain-specific embedding model is trained using one or more of a contrastive learning objective, a reconstruction-based learning objective, or a semi-supervised objective combining labeled data (where available) with unlabeled data. The domain-specific training produces an embedding space in which patches depicting similar built-environment features are closer than patches depicting dissimilar features, providing a representation tailored to the technical problem of built-environment analysis.

In some embodiments, the system supports multi-modal queries in which the query comprises a textual descriptor that is embedded into the same embedding space as the image-derived patch embeddings, enabling search for structures matching a natural language description.

In some embodiments, the system employs hierarchical resolution processing in which broad-coverage, lower-resolution imagery is analyzed first at a coarse scale to identify candidate regions, and higher-resolution imagery is selectively retrieved and analyzed for those candidate regions, thereby reducing bandwidth consumption and computational overhead.

In certain embodiments, precomputed patch embeddings are stored in a searchable embedding index supporting both on-demand and batch queries over large geographic areas.

In some embodiments, the system records user feedback (for example, confirmations and mismatches) and uses the feedback as a training signal for refining the embedding model and adjusting patch extraction and aggregation parameters over time.

Technical advantages of the present invention include, without limitation, improved fidelity for domain-relevant built-environment attributes relative to generic embeddings, reduced labeling requirements through semi-supervised and unsupervised training, improved compute and bandwidth efficiency via hierarchical resolution processing, and configurable multi-scale aggregation that allows tailoring to different tasks and geographic scopes.

### BRIEF DESCRIPTION OF THE DRAWINGS

The accompanying drawings, which are incorporated in and constitute a part of this specification, illustrate various embodiments and together with the description serve to explain the principles of the invention.

FIG. 1 is a block diagram illustrating a system pipeline overview for patchwise multi-scale similarity analysis in accordance with one or more embodiments.

FIG. 2 is a diagram illustrating multi-scale patch extraction from an image showing patches at different spatial scales in accordance with one or more embodiments.

FIG. 3 is a block diagram illustrating a semi-supervised and unsupervised training architecture for a domain-specific embedding model in accordance with one or more embodiments.

FIG. 4 is a block diagram illustrating query processing and multi-scale similarity aggregation in accordance with one or more embodiments.

FIG. 5 is a flowchart illustrating a method for training a domain-specific embedding model in accordance with one or more embodiments.

FIG. 6 is a flowchart illustrating a method for performing inference and similarity-based query processing in accordance with one or more embodiments.

FIG. 7 is a flowchart illustrating a hierarchical resolution processing method in accordance with one or more embodiments.

FIG. 8 is a block diagram illustrating a computing system architecture suitable for implementing the systems and methods described herein in accordance with one or more embodiments.

FIG. 9 is a block diagram illustrating a feedback and continuous refinement loop in accordance with one or more embodiments.

FIG. 10 is a block diagram illustrating deployment architecture options including cloud, edge-cloud hybrid, and on-premises configurations in accordance with one or more embodiments.

### DETAILED DESCRIPTION OF THE INVENTION

### General

Various illustrative embodiments will now be described more fully with reference to the accompanying drawings. It should be understood that there is no intent to limit the illustrative embodiments to the particular forms disclosed, but on the contrary, the illustrative embodiments are intended to cover all modifications, equivalents, and alternatives falling within the scope of the claims. Where appropriate, like reference numerals refer to like elements throughout the description of the figures.

It will be appreciated by those skilled in the art that the block diagrams illustrated herein represent conceptual views of illustrative system components, modules, and data flows. Similarly, it will be appreciated that any flowcharts, flow diagrams, and process descriptions represent various processes that may be substantially represented in computer-readable media and executed by one or more processors, whether or not such processors are explicitly shown.

The term “and/or” as used herein includes any and all combinations of one or more of the associated listed items. The terms “first,” “second,” and the like are used to distinguish elements and should not be construed as limiting elements to a particular order unless expressly stated.

### Definitions

The following definitions apply throughout this specification and claims unless the context clearly indicates otherwise.

The term “built-environment structure” as used herein refers to any human-made structure or a component thereof that is visible in aerial, satellite, drone, or ground-level imagery. Non-limiting examples include rooftops, building facades, siding, paving surfaces, parking structures, bridges, and other elements of the constructed environment. In some embodiments, the analysis focuses primarily on rooftops and roofing materials, though the system and method are not limited to rooftops.

The term “patch” as used herein refers to a spatially bounded sub-region of an image extracted at a defined spatial scale. A patch may depict a portion of one or more built-environment structures, a complete structure, or a portion of the surrounding environment. Patch-level processing deliberately restricts the spatial context available to the embedding model relative to whole-image processing, which can reduce boundary effects, support compositional analysis, and enable the system to independently embed and later aggregate information at multiple granularities.

The term “patch embedding” as used herein refers to a fixed-dimensional numerical vector representation of an image patch generated by processing the patch through an embedding model. The embedding captures features of the depicted content in a continuous vector space suitable for similarity computation.

The term “domain-specific embedding model” as used herein refers to a model trained on images of built-environment structures using training objectives and data that emphasize features relevant to the built-environment domain, as distinguished from generic image embedding models trained on broad image collections. Domain-specific training encourages the model to encode structural and material attributes that are salient for built-environment analysis rather than general aesthetic or scene-level features.

The term “multi-scale patch extraction” as used herein refers to extracting patches from one or more images at a plurality of different spatial scales, including at least one coarse scale and at least one fine scale.

The term “similarity metric” as used herein refers to a function that computes a score indicative of similarity or dissimilarity between two embeddings. Non-limiting examples include cosine similarity, Euclidean distance, dot product similarity, and learned distance functions.

The term “multi-scale aggregation” as used herein refers to combining similarity scores computed at a plurality of spatial scales into a single composite similarity result, optionally using configurable weighting parameters.

The term “query embedding” as used herein refers to an embedding generated from a user-provided query and mapped into the same embedding space as patch embeddings. The query may comprise one or more of an example image patch, a set of reference images, or a textual descriptor.

The term “patch library” as used herein refers to a stored collection of precomputed patch embeddings and associated metadata, optionally indexed using a vector database or other searchable data structure.

The term “composite similarity result” as used herein refers to an output of multi-scale aggregation representing an overall degree of match between a query and a candidate built-environment structure or region.

The term “cohort” as used herein refers to a group of structures or patches that cluster together in the embedding space based on one or more shared characteristics. Non-limiting cohort-defining characteristics include material type, condition level, age category, construction style, manufacturer, and geographic context.

The term “match score” as used herein refers to a numerical score indicative of similarity between a query and a candidate structure or region, including one or more scale-specific similarity scores and a composite similarity result. In some embodiments, a match score is used to rank candidate structures, to filter results against a configurable threshold, or to present to a user as an indicator of match quality.

The term “structured attribute representation” as used herein refers to a structured data object derived from one or more patch embeddings that enumerates estimated values for physical characteristics of a depicted built-environment structure, including one or more of material type, surface condition, color, structural style, estimated age, or other domain-relevant attributes.

The term “spatial scale” as used herein refers to a granularity of patch extraction, ranging from coarse contextual coverage (capturing multiple structures or a block-level region) to fine localized detail (capturing a portion of a single structure surface). Different spatial scales capture different kinds of information; coarse scales tend to capture structural geometry and spatial arrangement, while fine scales tend to capture material texture and localized condition signals.

### System Architecture

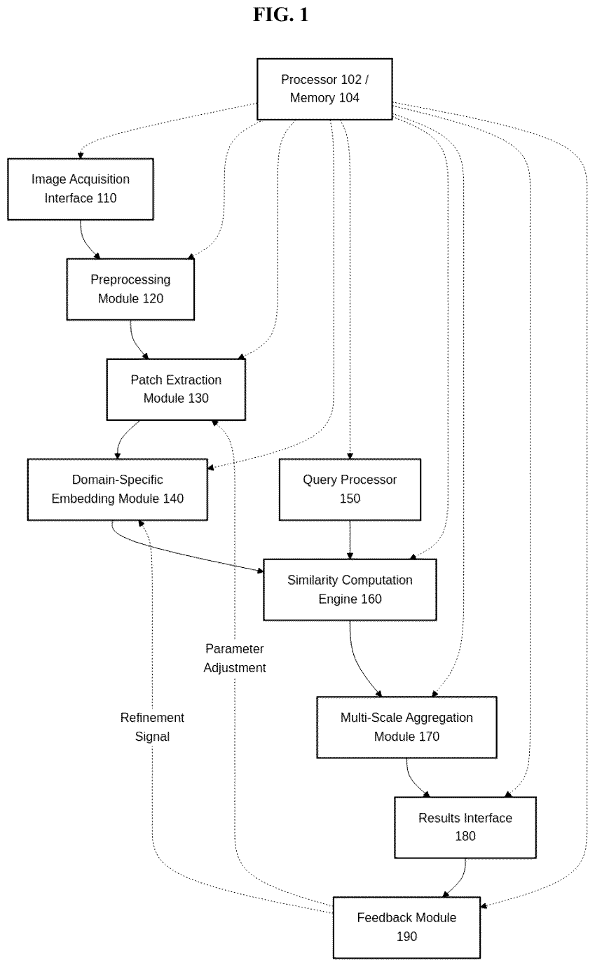

Referring now to FIG. 1, there is shown a system 100 for patchwise multi-scale similarity analysis of images depicting built-environment structures. System 100 includes an image acquisition interface 110, a preprocessing module 120, a patch extraction module 130, a domain-specific embedding module 140, a query processor 150, a similarity computation engine 160, a multi-scale aggregation module 170, a results interface 180, and a feedback module 190. System 100 further includes at least one processor 102 and at least one memory 104 storing instructions that, when executed by processor 102, implement the functions described herein.

Image acquisition interface 110 receives one or more images from one or more image sources. Non-limiting examples of image sources include satellite imagery providers, aerial survey platforms, drone capture systems, ground-level cameras (including mobile device cameras), and archived imagery databases. In some embodiments, interface 110 receives imagery responsive to a query. In other embodiments, interface 110 receives imagery in scheduled batch ingestion. In some embodiments, interface 110 receives imagery at multiple resolutions from the same or different sources for the same geographic area.

Preprocessing module 120 optionally applies one or more enhancement operations before patch extraction. In some embodiments, preprocessing includes superresolution to improve effective resolution of lower-quality imagery, denoising to reduce compression artifacts and sensor noise, and edge enhancement to accentuate structure boundaries and transitions between materials or surface regions. In some embodiments, preprocessing is bypassed when input imagery is of sufficient quality for direct patch extraction.

In some embodiments, preprocessing module 120 applies radiometric normalization to compensate for variation in illumination, atmospheric conditions, and sensor characteristics across images acquired from different sources, times, or conditions. Such normalization can improve the consistency of downstream patch embeddings by reducing appearance variation attributable to capture conditions rather than structural attributes.

Patch extraction module 130 segments imagery into patches at a plurality of spatial scales. In one non-limiting embodiment, patches are extracted at a coarse scale, a medium scale, and a fine scale. Coarse patches may encompass multiple structures or a block-level region. Medium patches may correspond to approximately one structure. Fine patches may correspond to a portion of a structure surface such as a section of roofing material or a localized area of potential damage. The number of scales, the patch extents, and the extraction resolution are configurable and may be selected based on the target application.

In some embodiments, patch extraction module 130 extracts overlapping patches such that adjacent patches share a configurable portion of spatial extent. Overlap can reduce boundary blind spots and preserve continuity of features that span patch boundaries. In some embodiments, the overlap percentage is configurable, for example between approximately 10% and approximately 50% of patch extent, and may be adjusted based on processing priorities. In some embodiments, overlap is reduced or disabled to improve throughput when boundary fidelity is less critical.

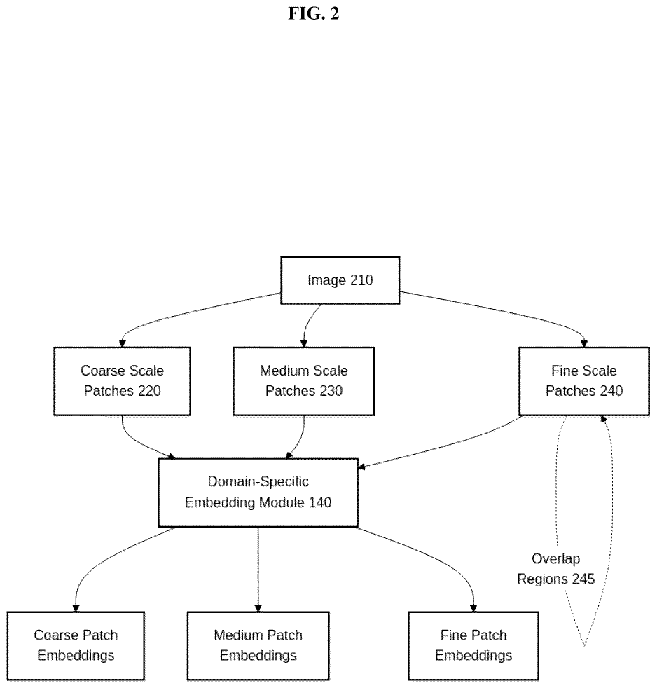

Referring also to FIG. 2, an image 210 is segmented at a coarse scale into patches 220, at a medium scale into patches 230, and at a fine scale into patches 240. Overlap regions 245 may be present between adjacent fine-scale patches. Patches produced at each scale are provided to the embedding module 140. It will be appreciated by those skilled in the art that the number of spatial scales is not limited to three and that additional or fewer scales may be used depending on the application and the characteristics of the input imagery.

Domain-specific embedding module 140 generates patch embeddings for extracted patches. In some embodiments, module 140 comprises a trained neural network architecture including one or more of convolutional layers and attention-based layers. Non-limiting examples include convolutional neural networks (CNNs), Vision Transformers (ViTs), residual networks (ResNets), densely connected networks (DenseNets), and hybrid architectures combining convolutional and attention layers. Architectural parameters such as embedding dimension, layer count, and receptive-field behavior are design choices and are not limited to any particular values.

In some embodiments, the embedding model is implemented using a Vision Transformer backbone. In one non-limiting example, the backbone comprises a ViT-Large architecture that divides an input patch image into a grid of sub-patches (for example, 16-by-16 pixel sub-patches from a 224-by-224 pixel input), applies positional encoding, and processes the resulting sequence through a stack of transformer encoder blocks to produce a fixed-dimensional embedding vector (for example, a 1024-dimensional vector). In other embodiments, a convolutional backbone, a hybrid backbone, or another architecture is used. The selection of backbone architecture is a design choice.

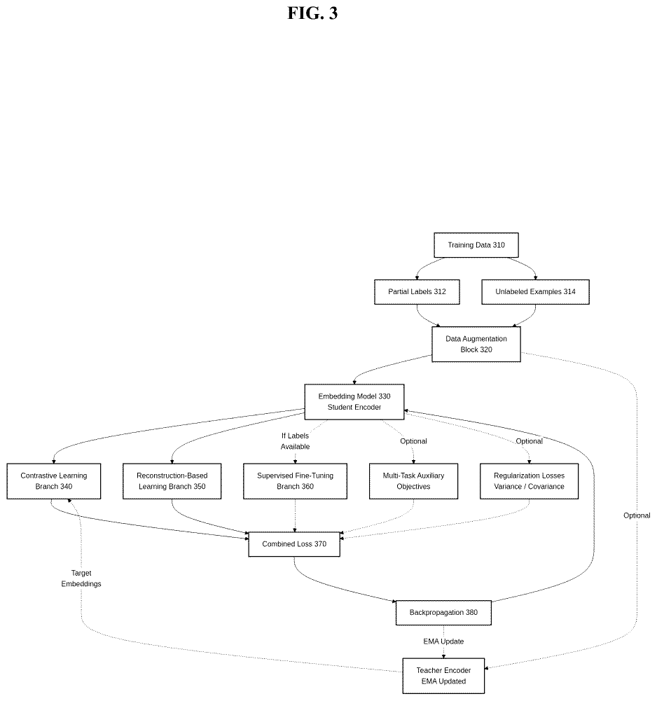

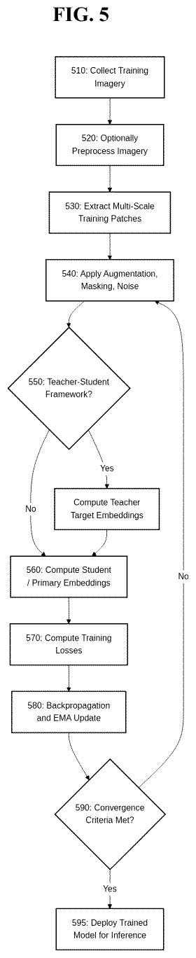

Module 140 is trained using at least one of semi-supervised learning or unsupervised learning on training images of built-environment structures, as described with respect to FIG. 3 and FIG. 5. In some embodiments, training objectives are selected such that embeddings encode domain-relevant attributes including, without limitation, material type, structural form, surface condition indicators, color characteristics, reflectance properties, granule distribution, and degradation patterns.

In some embodiments, training on patches extracted at different spatial scales causes the model to learn different kinds of features at different scales. For example, coarse patches encourage learning of structural geometry and layout, while fine patches encourage learning of localized surface texture and material characteristics. In some embodiments, separate prediction heads or loss terms are used for different spatial scales to encourage scale-dependent specialization, though such separation is not required.

In some embodiments, patch-level operation is a deliberate system design choice that restricts spatial context relative to whole-image processing. This restricted-context operation means that each patch is independently embedded without full-image boundary effects, which supports compositional analysis in which individual patches are independently embedded and then compared and aggregated. This approach differs structurally from whole-image embedding approaches in that the system operates on low-context patches and relies on the aggregation step to combine local and contextual information, rather than requiring each embedding to encode the full image context. The patch-based design also differs from conventional fixed-size sliding window approaches in that the present system extracts patches at a plurality of purposefully selected spatial scales, where each scale is selected to capture a different kind of information relevant to built-environment analysis. In a conventional sliding window, a single window size traverses an image at a fixed stride, and each window captures the same kind of information at the same granularity. By contrast, the multi-scale patch extraction of the present system produces patches at each spatial scale that serve a distinct analytical purpose: coarse patches encode the structural geometry, spatial arrangement, and neighborhood-level context of built-environment structures, while fine patches encode localized surface characteristics such as material texture, granule distribution, edge conditions, surface degradation patterns, and component-level detail. Medium patches, where employed, may encode individual-structure shape, roof form, and overall material composition. Because each scale captures fundamentally different information, the subsequent aggregation across scales produces a composite result that reflects both broad context and fine detail in a way that a single-scale sliding window approach cannot achieve. This multi-scale design is further enhanced by training the domain-specific embedding model on patches extracted at varied spatial scales, which encourages the model to learn scale-dependent representations. When the model processes a coarse patch, it learns to extract features related to geometry and spatial layout; when it processes a fine patch, it learns to extract features related to surface texture and material composition. This scale-dependent specialization arises naturally from the variation in information content at different scales and is reinforced by the training objectives.

It will be appreciated by those skilled in the art that the technical contribution disclosed herein is not the selection of any particular neural network architecture for the embedding model, but rather the system-level architecture in which imagery is purposefully partitioned into patches at a plurality of spatial scales, each scale capturing a different kind of domain-relevant information; the patches are independently embedded using a model trained specifically on built-environment structures via semi-supervised or unsupervised learning to encode domain-relevant structural and material attributes; and the resulting scale-specific similarity scores are aggregated across scales to produce a composite result. A conventional approach of passing a whole image or a single fixed-size crop through a convolutional neural network or other image classifier produces a single embedding for the input at one granularity level, without the multi-resolution embedding structure, the cross-scale aggregation, or the domain-specific training that characterize the present system. The present invention operates at the system and method level, and any of a variety of neural architectures, including convolutional neural networks, vision transformers, hybrid architectures, residual networks, and densely connected networks, may serve as the embedding backbone without departing from the scope of the claims.

In some embodiments, the domain-specific training approach produces an embedding space that encodes fundamentally different information than would be encoded by a generic feature extractor applied to the same imagery. Because the training objectives (including contrastive, reconstruction-based, and multi-task auxiliary objectives) are designed to emphasize attributes relevant to built-environment analysis, and because the training data comprises imagery of built-environment structures rather than general-purpose image collections, the resulting embeddings are concentrated on the feature dimensions most informative for distinguishing built-environment materials, conditions, and structural characteristics. This domain concentration enables a smaller, purpose-trained model to achieve a level of fidelity on domain-relevant tasks that may not be achievable by a larger general-purpose model, because the representational capacity of the smaller model is allocated entirely to the target domain. In some embodiments, this domain concentration further enables deployment on resource-constrained edge devices without the performance degradation that would accompany distillation of a general-purpose model to the same computational budget.

Query processor 150 receives a user query and generates a query embedding in the same embedding space as patch embeddings. In some embodiments, the query comprises one or more example image patches or one or more reference images. In such embodiments, the query embedding is generated by processing the example patch or reference images through the domain-specific embedding model or a compatible embedding pathway.

In some embodiments, the query comprises a textual descriptor. In such embodiments, query processor 150 includes a text embedding component that maps the textual descriptor into the shared embedding space. The text embedding component may be trained jointly with the image embedding model, aligned to the image embedding space using a multi-modal objective, or implemented using another alignment mechanism. In some embodiments, a composite query embedding is generated from both visual and textual query elements.

Similarity computation engine 160 computes similarity scores between patch embeddings and the query embedding using one or more similarity metrics. In some embodiments, similarity metrics include cosine similarity, Euclidean distance, dot product similarity, and learned distance functions. In some embodiments, the similarity metric is configurable and may be selected based on the query type or the target task.

In some embodiments, the similarity metric comprises a learned distance function trained using feedback data, labeled examples, or self-supervised signals. In such embodiments, the learned distance function may comprise a small neural network that receives two embeddings and produces a scalar similarity score. In other embodiments, the similarity metric is a fixed mathematical function such as cosine similarity.

Multi-scale aggregation module 170 combines scale-specific similarity scores into a composite similarity result. In some embodiments, aggregation comprises a weighted combination across scales with configurable weights corresponding to the spatial scales. The weights may be set by a user, learned from feedback, or selected based on query characteristics.

In some embodiments, aggregation module 170 supports non-linear aggregation functions in addition to or as an alternative to weighted linear combinations. In some embodiments, an attention-based aggregation mechanism learns to weight scale contributions based on the query embedding and the distribution of scale-specific scores. The selection of aggregation function is a design choice and is not limited to any particular function.

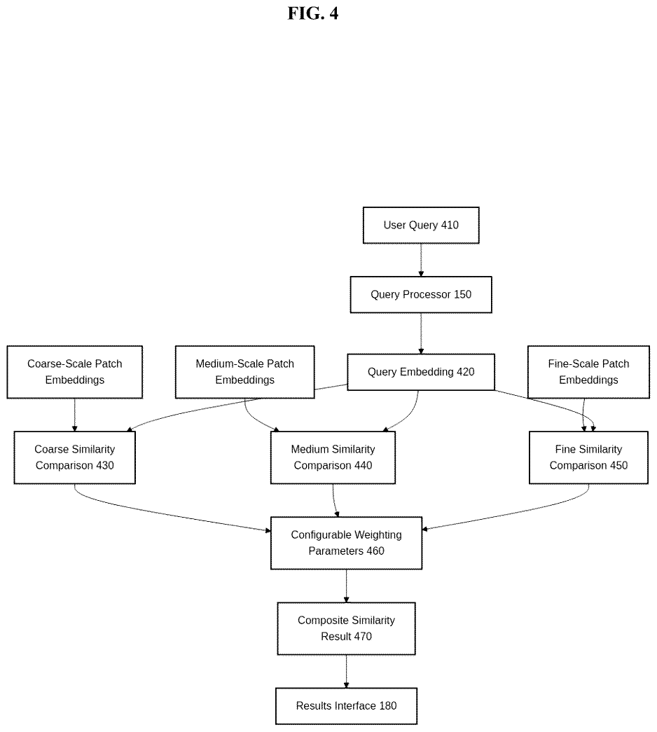

Referring also to FIG. 4, a user query 410 is processed by query processor 150 to generate a query embedding 420. Query embedding 420 is compared against patch embeddings at multiple scales (430, 440, 450) to produce scale-specific similarity scores. Multi-scale aggregation module 170 applies configurable weighting parameters 460 to produce a composite similarity result 470 that is output by results interface 180.

In some embodiments, when a candidate structure corresponds to multiple patches at a given spatial scale (for example, due to overlap), the similarity computation engine 160 computes an intra-scale aggregate (for example, maximum, mean, or median similarity) before applying cross-scale aggregation. This intra-scale aggregation ensures that the composite result reflects the best-matching or average-matching region within each scale for a given candidate structure.

Results interface 180 outputs results derived from composite similarity results and match scores. Non-limiting outputs include ranked lists of properties or addresses sorted by composite similarity score, map visualizations highlighting matching regions, and match scores for specified addresses. In some embodiments, results interface 180 provides drill-down views of scale-specific similarity contributions and the underlying patches that contributed to a match, enabling a user to understand which scales and which localized features drove a particular result.

Feedback module 190 collects user feedback regarding returned results. In some embodiments, users confirm correct matches or flag mismatches. Feedback signals may be stored and incorporated into subsequent training cycles, and may be used to adjust patch extraction and aggregation parameters.

In some embodiments, patch embeddings for a region are stored in an embedding index (for example, in a vector database or other approximate nearest-neighbor structure) and similarity computation is performed by querying the index for nearest neighbors to the query embedding. In other embodiments, embeddings are computed on-demand and compared directly. The selection of indexing and retrieval approach is a matter of design choice.

### Domain-Specific Embedding Model Training

Referring now to FIG. 3, training data 310 comprises images of built-environment structures collected from one or more sources. In some embodiments, training data includes diverse geographies, climates, and construction eras to promote generalization. In some embodiments, a portion of training data includes partial labels 312 (for example, known material types or known condition assessments), while a remaining portion includes unlabeled examples 314.

Training patches are extracted at multiple spatial scales consistent with the extraction described above. A data augmentation block 320 applies one or more augmentation operations, including synthetic variations, masking, noise insertion, and geometric transformations. In some embodiments, masking and noise insertion encourage robustness to occlusions, imaging artifacts, and background clutter commonly present in aerial and satellite imagery of built-environment structures.

In some embodiments, the training pipeline employs an asymmetric augmentation strategy in which patches processed by a student pathway receive stronger augmentations than patches processed by a teacher pathway. In one non-limiting embodiment, the student pathway applies color jitter, random grayscale conversion, Gaussian blur, random contrast adjustment, random erasing, additive Gaussian noise, salt-and-pepper noise, and simulated compression artifacts. The teacher pathway receives lighter augmentations, such as mild color jitter, to provide a more stable target signal. Augmentation parameters (strengths, probabilities, and ranges) are configurable. The asymmetric strategy encourages the student to learn representations that are invariant to common imaging degradations encountered in built-environment imagery.

In some embodiments, augmentation operations further include spatial transformations such as random resized cropping, random flipping, random affine transforms with limited rotation and translation, and random perspective transforms. In some embodiments, when training images include temporally paired imagery of the same structure captured at different timestamps, a shared geometric transform is applied to both images of a pair to preserve relative spatial correspondence, while independent appearance augmentations are applied separately.

In a contrastive learning branch 340, embeddings are trained such that patches that are semantically similar under a selected notion of similarity are embedded closer than semantically dissimilar patches. In some embodiments, similarity and dissimilarity are derived from data augmentations, spatial adjacency, temporal proximity, or other weak signals. In certain embodiments, labeled examples are used to define positives and negatives.

In a reconstruction-based learning branch 350, the model is trained to reconstruct masked or corrupted portions of a patch. In some embodiments, reconstruction is implemented using an autoencoder architecture or another reconstruction-based self-supervised learning framework.

In some embodiments, the training architecture employs a teacher-student framework in which a student encoder is trained with gradient-based optimization and a teacher encoder is maintained as an exponential moving average (EMA) of the student encoder. The teacher encoder generates target embeddings against which the student's predictions are compared, and the teacher's parameters are updated after each optimization step using an EMA decay parameter. In one non-limiting embodiment, the EMA decay parameter is set to approximately 0.996, though other decay values may be used. The teacher encoder does not receive gradient updates directly and is maintained in an evaluation mode in which stochastic layers (such as dropout) are disabled. The teacher-student framework provides temporally smoothed training targets that can improve training stability and embedding quality.

In some embodiments, the student encoder receives a time-conditioned input that encodes a temporal offset between imagery captures at different timestamps. In one non-limiting embodiment, the temporal offset is encoded using sinusoidal positional encoding followed by a learned projection, and the resulting time embedding is applied to the student's feature representation via feature-wise linear modulation (FiLM) in which a learned scale and bias transform the feature representation based on the time embedding. This conditioning enables the model to account for temporal changes between imagery captures when predicting embeddings. The teacher encoder, which provides target embeddings, does not receive time conditioning. In some embodiments, the time embedding supports month-level granularity using multi-band sinusoidal encoding with learnable per-band scale and bias parameters, enabling the model to capture both sub-annual changes and long-term trends.

In some embodiments, the training pipeline computes a prediction loss based on a distance or similarity between the student's predicted embedding and the teacher's target embedding. In one non-limiting embodiment, the prediction loss comprises a cosine distance between the normalized predicted embedding and the normalized target embedding, such that the loss is scale-invariant. In other embodiments, the prediction loss comprises a mean squared error or another distance metric.

In some embodiments, the training pipeline further computes a cycle consistency loss that encourages temporal reversibility of predictions. In one non-limiting embodiment, a forward prediction is generated from an embedding at a first timestamp to predict an embedding at a second timestamp, and a reverse prediction is generated from the forward prediction back to the first timestamp, with the cycle consistency loss computed as the distance between the reverse prediction and the original embedding. The cycle consistency loss can improve temporal coherence of the embedding space.

In some embodiments, the training pipeline further includes embedding regularization losses to prevent representation collapse in which all embeddings converge to a single point or a low-dimensional subspace. In one non-limiting embodiment, a variance loss encourages each embedding dimension to maintain a target standard deviation across a training batch, thereby preventing collapse. In some embodiments, a covariance loss penalizes correlations between different embedding dimensions, encouraging decorrelation so that each dimension encodes distinct information. In one non-limiting embodiment, the variance loss and the covariance loss are weighted by respective configurable coefficients. These regularization losses may be used independently or in combination.

In some embodiments, the training pipeline includes one or more multi-task auxiliary objectives in addition to a primary prediction objective. The auxiliary objectives operate on the same embedding space and encourage the embeddings to encode diverse information useful for downstream similarity tasks. In some embodiments, the auxiliary objectives are individually enabled or disabled via configuration and their respective loss weights are configurable. In some embodiments, the auxiliary objectives include one or more of: a denoising objective in which the model reconstructs a clean image from a corrupted input; an instance discrimination objective in which the model distinguishes embeddings of the same structure from embeddings of different structures; a temporal ordering objective in which the model predicts which of two images of a structure was captured earlier; a time gap prediction objective in which the model estimates the temporal distance between two captures; an intruder detection objective in which the model identifies an out-of-distribution image among a set of images from a common location; a change ranking objective in which the model determines which of two pairs of images exhibits greater change; a backward prediction objective that predicts an earlier embedding from a later embedding; and an interpolation objective that predicts an intermediate embedding between two temporally spaced embeddings.

In some embodiments, the denoising auxiliary objective trains a decoder module to reconstruct a clean patch from a corrupted patch embedding. In one non-limiting embodiment, corruption operations include one or more of additive Gaussian noise, Gaussian blur, simulated compression artifacts, salt-and-pepper noise, and random masking. The decoder may comprise one or more linear layers followed by a series of transposed convolution layers that upsample the embedding to the original image resolution. In some embodiments, the denoising loss comprises a pixel-level reconstruction loss, optionally supplemented by a perceptual loss.

In some embodiments, the instance discrimination auxiliary objective trains the model to produce embeddings that are similar for images of the same structure captured at different times and dissimilar for images of different structures. In one non-limiting embodiment, the objective is formulated as an InfoNCE-style contrastive loss with temperature scaling, in which same-structure images form positive pairs and different-structure images form negative pairs within a training batch.

In some embodiments, the temporal ordering auxiliary objective trains a classifier to determine, given embeddings of two images of the same structure captured at different times, which image was captured first. In some embodiments, the time gap prediction objective trains a regression or classification head to estimate the magnitude of the time gap between two captures. In some embodiments, the time gap is discretized into a configurable number of buckets for classification.

In some embodiments, the intruder detection auxiliary objective presents a set of images predominantly from one structure location along with one image from a different location, and trains the model to identify the intruder image. In some embodiments, the intruder detection head comprises an attention-based pooling mechanism that computes pairwise similarities among the set members and identifies the outlier. In some embodiments, the change ranking auxiliary objective presents two pairs of images and trains the model to determine which pair exhibits greater temporal change. These objectives encourage the embedding space to encode location-specific and change-sensitive information.

In some embodiments, a backward prediction auxiliary objective trains the model to predict an earlier embedding from a later embedding, and an interpolation auxiliary objective trains the model to predict an intermediate embedding given a start embedding, an end embedding, and corresponding temporal offsets. In one non-limiting embodiment, the interpolation predictor computes a learned weight between the start and end embeddings based on the temporal offsets, and applies a refinement network to produce the predicted intermediate embedding. These bidirectional and intermediate prediction objectives encourage temporal smoothness and symmetry in the embedding space. Architectural details for auxiliary task heads (for example, the number of layers, hidden dimensions, and activation functions) are design choices and may be configured based on available computational resources and the target task complexity.

In embodiments where partial labels are available, a supervised fine-tuning branch 360 computes a supervised loss on labeled examples and combines the supervised loss with one or more unsupervised losses.

A combined loss 370 aggregates contributions from active branches and backpropagation 380 updates parameters of embedding model 330. In some embodiments, the relative weighting of supervised and unsupervised components is tunable. In some embodiments, only unsupervised objectives are used and no labeled data is required.

In some embodiments, the combined loss function aggregates a primary prediction loss, one or more regularization losses (such as variance and covariance losses), one or more auxiliary task losses, and, optionally, one or more supervised losses, each weighted by a respective configurable coefficient. In one non-limiting embodiment, coefficients are selected such that the primary prediction loss and regularization losses collectively anchor the embedding space against collapse, while auxiliary task losses provide complementary learning signals that enrich the embedding representation. The specific loss weights are tunable and the selection of active loss components is a design choice.

In one non-limiting example training configuration, the embedding model uses a Vision Transformer backbone with a large variant (for example, approximately 300 million parameters) producing an embedding dimension of 1024 from 224-by-224 pixel input patches divided into 16-by-16 pixel sub-patches. The optimizer comprises AdamW with a base learning rate of 1e-4, weight decay of 0.05, and a cosine annealing learning rate schedule with a linear warmup phase. The teacher EMA decay is set to 0.996 and updated after each optimizer step. Gradient clipping is applied with a maximum gradient norm of 1.0, and mixed-precision training (for example, bfloat16) is used for computational efficiency. These parameters are illustrative and not limiting; other architectures, embedding dimensions, optimizers, and schedules may be used.

In one non-limiting example multi-task configuration, the auxiliary objectives are enabled with configurable loss weights. In one illustrative configuration, a denoising objective has a loss weight of 0.5, an instance discrimination objective has a loss weight of 0.3, a temporal ordering objective has a loss weight of 0.2, a time gap prediction objective has a loss weight of 0.2, and additional auxiliary objectives (such as intruder detection, change ranking, backward prediction, and interpolation) have respective loss weights in the range of 0.1 to 0.5. The primary prediction loss has a loss weight of 2.0, a variance regularization loss has a loss weight of 10.0, and a covariance decorrelation loss has a loss weight of 0.5. These illustrative weights are provided as one non-limiting example and are not intended to limit the scope of possible configurations.

In some embodiments, training data quality filtering is applied to exclude low-quality patches from training. In one non-limiting embodiment, patches with a ratio of dark or black pixels exceeding a configurable threshold (for example, 50% of pixels) are excluded from training batches. Quality filtering reduces the influence of failed image loads, severely degraded imagery, and occluded patches on the learned embedding space.

Referring now to FIG. 5, method 500 illustrates an example training process. At step 510, training imagery is collected from one or more sources depicting built-environment structures across diverse geographies and conditions. At step 520, imagery is optionally preprocessed (for example, using superresolution or denoising). At step 530, multi-scale training patches are extracted at a plurality of spatial scales. At step 540, augmentation, masking, and noise insertion is applied. At step 550, if a teacher-student training framework is used, teacher target embeddings are computed using the teacher encoder; otherwise this step is bypassed. At step 560, student or primary embeddings are computed for the training batch. At step 570, one or more training losses are computed, including one or more of prediction loss, regularization losses, auxiliary task losses, and supervised loss (where labels are available). At step 580, model parameters are updated via backpropagation and, in embodiments using a teacher-student framework, the teacher encoder parameters are updated via the EMA update. At step 590, convergence is evaluated against one or more convergence criteria. If convergence criteria are not met, the method returns to step 540 for additional training iterations. At step 595, the trained model is deployed for inference.

### Similarity Computation and Multi-Scale Aggregation

Similarity computation and aggregation begins with patch embeddings and a query embedding. Similarity computation engine 160 computes similarity scores at each available scale for candidate structures or regions, and aggregation module 170 combines scores across scales to produce composite similarity results.

In some embodiments, aggregation comprises computing a weighted sum, weighted mean, or other weighted combination across scale-specific similarity scores. In some embodiments, weights are configured to emphasize coarse geometry or fine texture depending on the query. For example, a query seeking structures with a particular roof shape may assign higher weight to the coarse scale, while a query seeking structures with a particular surface texture may assign higher weight to the fine scale.

In some embodiments, the similarity metric is configurable and may be selected from cosine distance, Euclidean distance, and learned metrics. In some embodiments, learned metrics are trained using feedback data, labeled examples, or self-supervised signals. In some embodiments, the choice of similarity metric is configurable per query or per deployment configuration.

### Inference and Query Processing

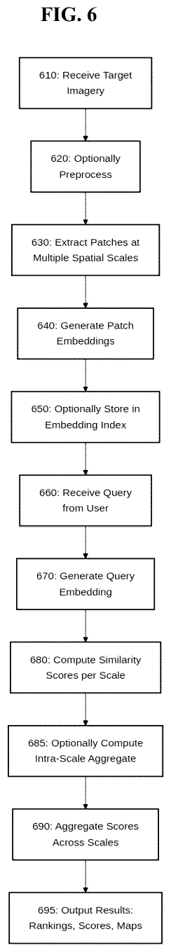

Referring now to FIG. 6, method 600 illustrates an example inference process. At step 610, target imagery is received depicting a geographic region containing one or more built-environment structures. At step 620, imagery is optionally preprocessed. At step 630, patches are extracted at multiple spatial scales, optionally with overlap. At step 640, patch embeddings are generated using the trained domain-specific embedding model. At step 650, embeddings are optionally stored in an embedding index. At step 660, a query is received from a user. At step 670, a query embedding is generated in the shared embedding space. At step 680, similarity scores are computed between the query embedding and patch embeddings at each spatial scale. At step 685, when a candidate structure corresponds to multiple patches at a given spatial scale, an intra-scale aggregate score is optionally computed. At step 690, similarity scores are aggregated across the plurality of spatial scales to produce one or more composite similarity results. At step 695, results are output, including one or more of ranked addresses, match scores, and map highlights.

In some embodiments, inference supports both real-time on-demand analysis and batch processing. In batch processing, patch embeddings may be precomputed for regions and stored in the embedding index for later querying. In on-demand analysis, embeddings may be generated at query time without persistent storage.

In some embodiments, the embedding index supports approximate nearest-neighbor (ANN) search to accelerate query processing over large collections of precomputed patch embeddings. Non-limiting indexing approaches include locality-sensitive hashing, hierarchical navigable small-world graphs, inverted file indices, and product quantization. The selection of ANN approach is a design choice.

In some embodiments, the system supports incremental index updates in which new patch embeddings are added to an existing embedding index without requiring full re-indexing of previously computed embeddings. Incremental indexing facilitates ongoing ingestion of updated imagery for a geographic region.

In some embodiments, the system supports scalability across geographic scopes ranging from a single structure to an entire metropolitan area or larger. The combination of multi-scale patch extraction, configurable spatial scales, hierarchical resolution processing, and partitioned indexing enables the system to operate efficiently at scales involving large numbers of structures without requiring uniform high-resolution processing of all imagery.

### Hierarchical Resolution Processing

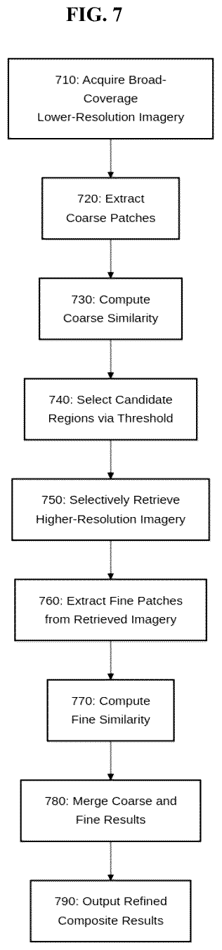

Referring now to FIG. 7, method 700 illustrates hierarchical resolution processing. At step 710, broad-coverage lower-resolution imagery is acquired for a region. At step 720, coarse patches are extracted. At step 730, coarse similarity is computed to identify candidate regions. At step 740, candidate regions are selected based on one or more thresholds applied to match scores at the coarse scale. At step 750, higher-resolution imagery is selectively retrieved for candidate regions. At step 760, fine patches are extracted from the selectively retrieved higher-resolution imagery. At step 770, fine similarity is computed for the fine patches. At step 780, coarse and fine results are merged to produce refined composite results. At step 790, refined results are output.

In some embodiments, candidate selection is based on one or more thresholds applied to match scores produced at the coarse scale. In some embodiments, the selective retrieval strategy is structured as a tree in which coarse tiles are evaluated before selectively fetching finer tiles, improving bandwidth and latency performance relative to processing all imagery at full resolution. This tree-structured approach allows the system to function as a search mechanism that dynamically allocates higher-resolution processing to the most relevant regions.

In some embodiments, reinforcement learning is used to select which regions to refine, where an agent iteratively selects candidate patches to zoom into or to reprocess at a finer scale based on reward signals associated with retrieval performance or task-specific objectives. The reinforcement learning policy may be trained to maximize retrieval precision, minimize total bandwidth consumption, or optimize another configurable objective.

In some embodiments, the hierarchical resolution strategy provides a substantial reduction in data transfer and processing requirements for regional-scale analysis. For example, an initial coarse pass over a large metropolitan area may eliminate a majority of tiles from further processing, and only a subset of candidate tiles is retrieved at higher resolution. This tiered approach can reduce overall bandwidth consumption, storage requirements, and processing time compared to uniform high-resolution processing. In some embodiments, the system treats lower-resolution imagery tiles as coarse patches in a first pass, generating coarse embeddings that enable rapid screening across a wide geographic area. Candidate tiles that exceed a configurable similarity threshold are then selectively expanded by retrieving higher-resolution imagery for those tiles, from which finer patches are extracted and embedded. This two-stage sampling technique enables the system to cover a geographic scope that would be computationally intractable at uniform high resolution, while concentrating high-resolution processing on the most relevant areas. It will be appreciated by those skilled in the art that this approach functions as a spatial search mechanism that balances coverage breadth against processing depth, adapting the allocation of computational resources based on the results of the coarse pass.

### Embedding Space Properties and Cohort Analysis

Domain-specific training produces an embedding space in which patches depicting similar built-environment features cluster together and patches depicting dissimilar features are distant. In some embodiments, clustering arises naturally from contrastive and reconstruction-based training without requiring explicit cluster labels.

In some embodiments, the system exploits clustering for cohort analysis. A cohort comprises a group of structures whose patch embeddings cluster together based on shared characteristics. Non-limiting cohort-defining characteristics include material type, condition level, age category, construction style, manufacturer, brand, and geographic context.

In some embodiments, the system applies a clustering algorithm to patch embeddings to identify cohorts. Non-limiting examples include k-means, density-based clustering, hierarchical clustering, and Gaussian mixture models. In other embodiments, cohorts are defined using reference embeddings or textual descriptors, and the system identifies structures within a threshold distance of the cohort definition.

In some embodiments, cohort analysis is used for differential analysis between cohorts, outlier detection within a cohort, and longitudinal tracking. In certain embodiments, imagery captured at different times is processed through the same embedding pipeline to observe changes in match scores and cohort membership over time.

In some embodiments, the system supports longitudinal tracking of individual structures or cohorts by comparing patch embeddings generated from imagery captured at multiple timestamps. Changes in embedding position over time can indicate changes in material condition, degradation progression, or modification to the structure. In some embodiments, the system computes a trajectory in the embedding space for a structure over time and identifies deviations from expected cohort trajectories.

In some embodiments, longitudinal tracking provides an observational framework analogous to a controlled study operating on built-environment structures in real-world conditions rather than laboratory conditions. By organizing structures into cohorts based on shared attributes and tracking the cohorts over time, the system may identify patterns of degradation, failure, or change that are difficult to observe in controlled settings alone. For example, a cohort of structures sharing a common material type but differing in geographic region or climate exposure may be tracked to identify how environmental factors correlate with degradation rates.

In some embodiments, temporal change detection is performed by comparing patch embeddings from different timestamps for the same geographic location. A change magnitude may be computed as a distance (for example, cosine distance or Euclidean distance) between the temporally spaced embeddings. In some embodiments, structures exhibiting change magnitudes above a configurable threshold are flagged for further review.

In some embodiments, the system supports differential cohort analysis in which two or more cohorts are compared to identify attributes that distinguish them. For example, structures sharing a common material but differing in geographic region, climate exposure, or installation era may be compared in the embedding space to identify condition or performance differences correlated with those distinguishing attributes. In some embodiments, an interpretable model (for example, a gradient-boosted decision tree) is trained on the embedding features to identify which embedding dimensions most strongly differentiate the cohorts, providing insight into the underlying structural or material factors driving the differentiation.

### Multi-Modal Sensor Fusion

In some embodiments, the system integrates additional data modalities beyond visual imagery to refine feature detection and embedding quality. Non-limiting additional modalities include multi-spectral imagery capturing reflectance at wavelengths beyond the visible spectrum, light detection and ranging (LiDAR) data providing three-dimensional surface geometry, and thermal imagery capturing surface temperature distributions. In some embodiments, data from additional modalities is aligned with the visual imagery and fused prior to or during embedding generation.

In some embodiments, multi-modal fusion is implemented by concatenating features derived from different modalities and processing the concatenated features through one or more fusion layers in the embedding model. In other embodiments, separate embedding pathways are used for each modality and the resulting modality-specific embeddings are combined (for example, via concatenation, summation, or attention-based fusion) to produce a fused patch embedding. The selection of fusion strategy is a design choice.

### Cross-Source Image Alignment

In some embodiments, patches derived from different capture sources are projected into the same embedding space. For example, a ground-level photograph of a structure surface captured by a mobile device camera may be embedded and compared against aerial or satellite patch embeddings of the same or similar structures. This cross-source comparison enables use cases in which a field inspector or contractor captures imagery on-site and queries the system for matching structures across a broader geographic area.

In some embodiments, cross-source alignment includes one or more normalization and alignment operations, such as geometric warping, scale normalization, and orientation normalization, to improve correspondence between ground-level and aerial patches. In some embodiments, alignment is performed prior to embedding to reduce domain shift between capture perspectives.

In some embodiments, the domain-specific embedding model is trained with cross-source training pairs, in which a ground-level image and an aerial image of the same structure are used as positive pairs during contrastive training. Such training encourages the embedding space to represent the same structure similarly regardless of capture source, improving cross-source query performance.

### Structured Attribute Extraction

In some embodiments, the system derives a structured attribute representation from one or more patch embeddings. In one embodiment, a decoder model or set of classification heads maps embeddings to structured attributes such as estimated material type, color category, condition indicators, structural style, and estimated age range.

In some embodiments, the structured attribute representation is formatted as a set of key-value pairs or another structured object enabling text-based search and filtering. For example, a user may specify constraints such as “material: asphalt shingle AND condition: moderate wear AND color: gray” and the system applies the structured constraints and similarity-based retrieval to return matching structures.

In some embodiments, the structured attribute representation is manipulated to perform counterfactual queries. For example, a user may modify an attribute value (such as color or material type) while holding other attributes constant and use the modified representation to query for similar structures matching the modified description. This allows search along specific attribute axes without requiring a representative input patch for each desired attribute combination.

In some embodiments, the structured attribute representation is formatted in a specification-driven schema that mirrors conventions used in the built-environment domain, including construction specifications, material data sheets, and inspection criteria. This alignment enables interoperability with existing specification-driven workflows and documentation systems. In some embodiments, a transpilation layer converts between the internal structured representation and one or more industry-standard specification formats. It will be appreciated by those skilled in the art that the built-environment domain is fundamentally specification-driven: construction materials are manufactured and installed against published specifications, warranties are tied to system-level compliance with those specifications, and inspection criteria reference specification standards. By formatting the structured attribute representation to reflect such specification conventions, the system enables end-to-end traceability from a visual observation (an image patch) to the specification-level characterization of the depicted structure. In some embodiments, the structured attribute representation is encoded as a set of fields corresponding to physical characteristics, where each field represents a measurable or classifiable attribute, and the set of fields collectively provides a machine-readable characterization of the structure analogous to a material specification or construction blueprint.

In some embodiments, the structured attribute representation is used to connect visual observations to specification-driven workflows in the built-environment domain, including linking results to manufacturer specifications, installation guidance, and warranty criteria.

In some embodiments, during training, specific fields of the structured attribute representation may be frozen while other fields remain trainable. This selective freezing allows the system to train classification or prediction heads tied to specific attributes (for example, material type) while holding other attributes constant, enabling targeted multi-task training across different attribute axes using a unified encoder-decoder architecture. In some embodiments, the unified encoder-decoder architecture permits a single trained embedding model to support a plurality of structured attribute extraction tasks by selectively activating or constraining different fields. For example, a material identification task may freeze condition-related fields and train only the material-type field, while a condition assessment task may freeze the material-type field and train the condition-related fields. This selective approach enables efficient multi-task utilization of the same underlying representation.

In some embodiments, the structured attribute representation can be used to generate text-to-text comparisons in which structured attributes extracted from different patches are compared at the attribute level rather than at the embedding level. Such attribute-level comparison enables interpretable, field-by-field analysis of similarities and differences between structures. In some embodiments, the structured representation enables a transpilation from the internal representation to a human-readable format that mirrors industry-standard specification formats, enabling practitioners in the built-environment domain to interpret and verify the system's outputs against existing specification-driven workflows without requiring expertise in the underlying embedding or similarity computation.

### Retrieval-Augmented Information Lookup

In some embodiments, the patch library and associated metadata serve as a retrieval backend for an information system, including a language model. In one embodiment, a query image is embedded, matching entries are retrieved from the patch library, and associated documentation is provided to the information system to generate contextual guidance about the matched structure. In some embodiments, the associated documentation includes manufacturer manuals, installation instructions, maintenance schedules, and product specifications.

In some embodiments, the patch embedding library functions as a key-value store in which patch embeddings serve as keys and associated documents serve as values. A user query (for example, a photograph taken by a field inspector) is embedded, nearest-neighbor matches are retrieved from the library, and the associated documentation for the matched entries is provided to a language model to generate a contextualized response to the user's query.

### Automatic Label Derivation From External Records

In some embodiments, training labels are derived automatically for a subset of patches by correlating imagery with external records such as maintenance records, inspection histories, warranty claims, permits, or weather event records associated with geographic locations. Automatically derived labels may supplement manual labels and feedback signals for semi-supervised training.

In some embodiments, automatically derived labels are treated as noisy labels and are assigned lower confidence weights during training relative to manually verified labels or high-confidence feedback signals. In some embodiments, the system progressively identifies additional labelable examples by using the model's current embedding space to find patches near confidently labeled clusters, gradually expanding the labeled training set.

### Patch Library and Embedding Index

In some embodiments, each patch embedding stored in the patch library is associated with metadata comprising one or more of geographic coordinates, capture timestamp, capture source identifier, spatial scale designation, image resolution, and, where available, structured attribute values. The metadata facilitates filtering, partitioning, and contextual retrieval of embeddings based on non-visual criteria.

In some embodiments, the system maintains a patch library comprising precomputed patch embeddings for structures across one or more geographic regions. The patch library may be partitioned by geography, time, capture source, or other metadata. The patch library serves as a reusable foundation for multiple downstream tasks. Because patch embeddings encode domain-relevant features in a task-agnostic vector space, the same library of precomputed embeddings can support diverse queries including material identification, condition assessment, damage detection, cohort analysis, trend analysis, and product tracking, without requiring re-extraction or re-embedding for each task. This library-based approach provides economies of scale in that the computational investment in embedding a geographic region is amortized across all queries and tasks performed against that region.

In some embodiments, the patch library includes canonical patch entries representing known reference materials, products, or installation patterns. Canonical entries may be associated with manufacturer identifiers, product specifications, or documentation links. Matching a query or field-captured patch against canonical entries enables product identification and specification lookup. For example, canonical patch entries representing known roofing products from various manufacturers may be stored with associated brand names, product line identifiers, and specification sheets, enabling the system to identify the specific product installed on a structure by comparing its patch embedding against the canonical entries.

In some embodiments, the patch library is stored in a vector database or another searchable data structure supporting nearest-neighbor queries. In other embodiments, embeddings are computed on-demand and compared directly without persistent storage.

In some embodiments, the system supports batch indexing of large imagery mosaics and subsequent interactive queries over the indexed embeddings. In some embodiments, the patch library is organized to function as a comprehensive asset inventory for a geographic region, in which each built-environment structure is represented by its multi-scale patch embeddings and associated metadata, and the entire collection is queryable using any supported query modality. The library-based architecture enables a plurality of distinct analytical workflows to operate against the same precomputed embedding collection without requiring reprocessing of the underlying imagery for each new task.

### Feedback and Continuous Refinement

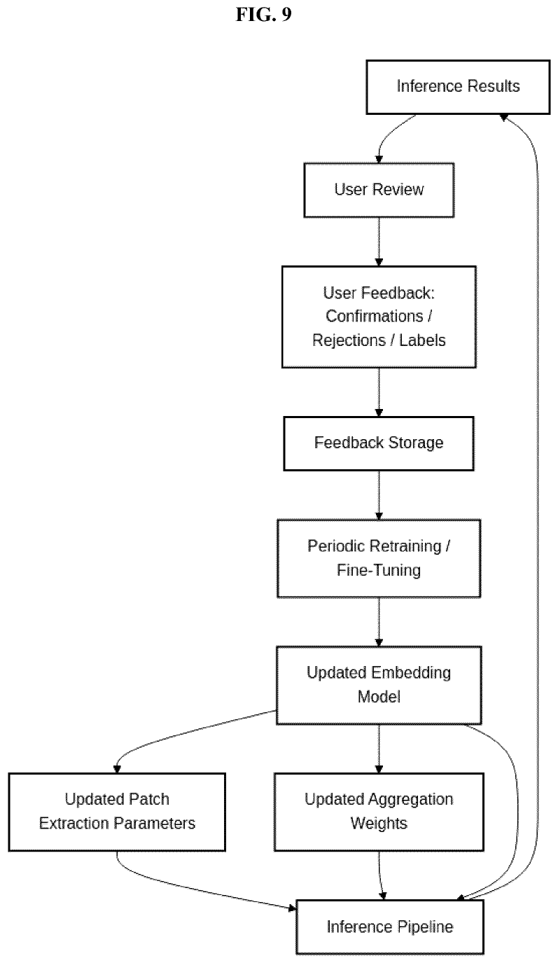

Referring now to FIG. 9, inference results are presented to a user and user feedback is collected. Feedback may include confirmations, rejections, corrected labels, or other annotations.

In some embodiments, feedback is stored and periodically incorporated into training or fine-tuning to refine the embedding space. In some embodiments, feedback is also used to adjust patch extraction parameters, overlap settings, and cross-scale weighting.

In some embodiments, the embedding model is periodically retrained to incorporate newly discovered materials, updated imagery, and emergent structural patterns.

In some embodiments, the system supports continuous refinement in which feedback collected during operational use is accumulated and used in periodic retraining cycles. In some embodiments, the retraining cycles are scheduled at regular intervals or triggered when a configurable volume of new feedback has been collected. Continuous refinement enables the system to adapt to changes in imagery characteristics, newly introduced construction materials, and shifts in the distribution of structures in the analyzed regions.

### Deployment Architecture

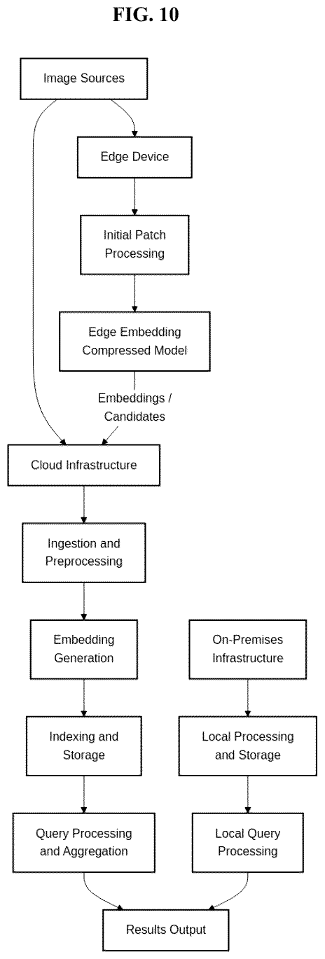

Referring now to FIG. 10, the system may be deployed in cloud-only, edge-cloud hybrid, or on-premises configurations. In cloud deployments, ingestion, embedding, indexing, and querying may be performed on cloud infrastructure. In on-premises deployments, processing and storage occur within a local environment to satisfy data sovereignty or privacy requirements.

In certain embodiments, an edge device performs initial patch processing and embedding generation and transmits embeddings or candidate regions to a remote server for refinement and aggregation. In some embodiments, the embedding model is compressed for edge deployment to reduce computational and memory requirements.

In some embodiments, model compression includes knowledge distillation in which a smaller student model is trained to approximate embeddings produced by a larger teacher model. The distilled student model may have fewer parameters and lower computational cost while maintaining a configurable level of embedding fidelity relative to the teacher model. In some embodiments, the domain-specific training approach described herein allows the distilled model to retain more domain-relevant performance than would be achieved by distilling a general-purpose model, because the original teacher model's representations are already concentrated on domain-relevant features rather than spread across general visual features.

In some embodiments, model compression includes weight pruning in which parameters with magnitudes below a configurable threshold are removed or set to zero, resulting in a sparser model with reduced storage and computation requirements.

In some embodiments, model compression includes quantization in which model parameters and activations are represented using a reduced numerical precision (for example, 8-bit integer representation instead of 32-bit floating point), reducing memory footprint and accelerating inference on hardware that supports reduced-precision arithmetic.

In some embodiments, one or more of knowledge distillation, weight pruning, and quantization are applied in combination to further reduce deployment resource requirements. The selection and combination of compression techniques is a design choice and depends on the target deployment platform and acceptable fidelity trade-offs.

In some embodiments, patches or embeddings may be prefetched and pushed to edge devices to enable local similarity computation with reduced network latency. In such embodiments, the edge device maintains a local subset of the patch library corresponding to a geographic region of interest, and similarity queries against the local subset can proceed without network access.

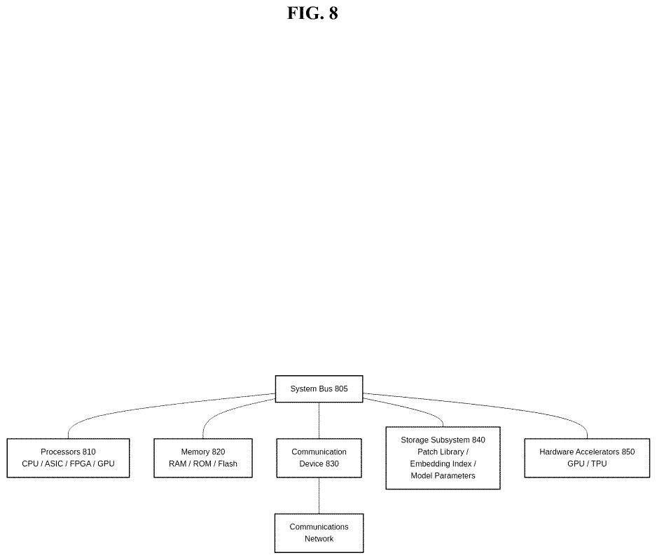

Referring now to FIG. 8, a computing system 800 suitable for implementing the systems and methods described herein includes one or more processors 810 coupled to a system bus 805. Processors 810 may comprise one or more central processing units (CPUs), application-specific integrated circuits (ASICs), field-programmable gate arrays (FPGAs), graphics processing units (GPUs), or combinations thereof. Processors 810 may have multiple processing cores.

Computing system 800 further includes a memory 820 for storing instructions and data. Memory 820 may comprise random access memory (RAM), read-only memory (ROM), flash memory, cache, or combinations thereof. Non-transitory computer-readable media may include volatile or non-volatile media, removable or non-removable media. Computing system 800 further includes a communication device 830 providing access to a communications network via a wireless or wired connection.

Computing system 800 further includes a storage subsystem 840 which may contain the patch library, the embedding index, and trained model parameters. In some embodiments, the storage subsystem includes one or more mass storage devices such as solid-state drives or magnetic disks. One or more hardware accelerators 850 (for example, GPUs or tensor processing units) may be coupled to bus 805 and used for embedding computation and similarity search operations.

Memory 820 stores software modules that provide functionality when executed by processors 810. The modules include an operating system and one or more application modules configured to perform all or part of the processes described herein. In some embodiments, computing system 800 operates in a client-server configuration in which client devices interact with the computing system via a network. In some embodiments, computing system 800 operates within a network-based cloud computing environment.

### Observability and Auditing

In some embodiments, the system records operational telemetry including query parameters, patch scale configurations, similarity metric selections, aggregation weights, model versions, and output match scores. Such telemetry supports reproducibility and auditing.

In some embodiments, the system stores and serves explainability artifacts, such as representative patches contributing to a match and scale-specific similarity contributions, to support user inspection and feedback.

In some embodiments, the system maintains an audit trail that associates each query result with the model version, embedding index version, configuration parameters, and imagery metadata used to generate that result. The audit trail supports traceability and enables reproduction of results for compliance, dispute resolution, or quality assurance purposes.

In some embodiments, the system supports model comparison in which results generated by a current model version and a candidate updated model version are compared side-by-side or evaluated against a test set to assess the impact of model updates before production deployment. Gradual rollout and model versioning reduce operational risk when updating the embedding model.

### Safety, Fallback, and Reliability

In some embodiments, the system applies thresholds to match scores to select candidate matches for user verification and to reduce false positives in downstream actions. In some embodiments, results presentation emphasizes non-limiting decision support rather than automatic enforcement.

In some embodiments, the system detects missing or low-quality imagery and falls back to a coarser scale, to alternative imagery sources, or to deferred batch processing. In some embodiments, the system logs such events for later remediation.

In some embodiments, the system supports model versioning and gradual rollout of updated embedding models to reduce operational risk when updating models over time.

In some embodiments, when imagery for a target region is partially unavailable, the system produces partial results covering the available portions and indicates the regions for which results are unavailable or produced with reduced confidence.

### Application Domains and Use Cases

In one example, a materials supplier scans a city for a target roofing material type. Coarse patches identify candidate rooftops and fine patches confirm texture, and the system outputs addresses and match scores.

In another example, a contractor searches for subtle damage patterns across a neighborhood. Overlapping fine patches capture localized cracks or curling, and the system outputs a ranked lead list.

In another example, regional trend analysis is performed by scanning wide areas with coarse patches, clustering similar structures in an embedding space, and refining selected regions with fine patches to characterize materials and conditions.

In another example, a field inspector assesses construction compliance by capturing a ground-level photograph of a structure surface and comparing it to canonical references representing compliant installations, returning an assessment and match score. In some embodiments, the assessment indicates the degree of similarity between the field-captured image and the canonical reference and identifies specific patches where deviations are detected.

In another example, a quality assurance or fraud detection application compares field-captured imagery against a canonical patch library to verify that an installed material matches a claimed specification. Deviations between the field patch embeddings and the canonical reference embeddings may be flagged for further review.

In another example, a manufacturer uses the system to identify structures across a geographic region that exhibit characteristics consistent with a specific product line, supporting product tracking, recall analysis, and warranty management. The system compares regional patch embeddings against canonical product embeddings and returns matching structures with associated addresses and match scores.

In another example, a historical preservation entity identifies structures exhibiting vintage construction materials or architectural styles by querying the patch library with reference patches or textual descriptors representing the target style or material.

In another example, the system analyzes imagery of a geographic region to delineate neighborhood boundaries based on transitions in built-environment characteristics detected through changes in cohort composition and embedding distributions.

In another example, an insurance or warranty management entity uses the system to analyze imagery of structures associated with active policies or warranties, comparing current patch embeddings against historical patch embeddings for the same structure to identify changes in condition, and correlating detected changes with claims or coverage criteria.

In another example, the system is used to analyze the distribution of construction materials across a geographic region by computing patch embeddings for a large imagery dataset, clustering the embeddings, and generating summary statistics and visualizations of material prevalence by sub-region.

In another example, a user captures a ground-level photograph of a structure surface using a mobile device, the system embeds the photograph and retrieves matching entries from the patch library, and associated documentation such as manufacturer specifications or installation guides is presented to the user via a retrieval-augmented response.

In another example, fire code compliance analysis is performed by comparing roofing material patch embeddings against reference embeddings for fire-rated and non-fire-rated materials, identifying structures that may not meet applicable fire cladding requirements. In some embodiments, the system provides real-time or near-real-time visualization of similarity results and structured attribute information via augmented reality or mixed reality interfaces. For example, a field inspector wearing augmented reality glasses or using a mobile device with augmented reality capabilities may view overlay annotations on a live view of a built-environment structure, where the annotations indicate identified material type, condition assessment, match score relative to a query, or other attributes derived from the patch analysis pipeline. In some embodiments, the augmented reality interface presents information derived from the structured attribute representation alongside the visual field of view, enabling the inspector to compare observed conditions against the system's analysis without switching between devices or applications.

In certain embodiments, the system extends beyond roofing to other built-environment structure features such as siding, windows, paving surfaces, and parking structures by adapting training data and objectives to emphasize the relevant attributes. The multi-scale patch extraction and similarity aggregation pipeline is applicable to any domain in which imagery of structures is analyzed at varying spatial scales.

### Example Configurations

In one example configuration, multi-scale patches are extracted from aerial imagery at three spatial scales, patch embeddings are generated using a domain-specific embedding model trained using contrastive and reconstruction-based objectives, and similarity is computed using cosine similarity with configurable scale weights.

In another example configuration, patch embeddings for a region are precomputed and stored in a vector database for interactive querying. Hierarchical resolution processing is enabled such that high-resolution imagery is selectively retrieved for candidate regions identified during a coarse pass.

In another example configuration, a compressed embedding model is deployed on an edge device to generate embeddings for ground-level photographs, which are compared to an aerial patch library for cross-source alignment use cases.

In another example configuration, the training pipeline is configured with a teacher-student framework using EMA updates, contrastive prediction loss, variance and covariance regularization, and a configurable set of multi-task auxiliary objectives. The model is trained for a configurable number of epochs with a cosine annealing learning rate schedule and periodic evaluation. This configuration is illustrative and not limiting.

In another example configuration, the system is configured for longitudinal analysis in which imagery captured at multiple timestamps is processed through the same embedding pipeline, structures are organized into cohorts, and changes in cohort membership and embedding position are tracked over time.

In another example configuration, the system processes imagery at a regional scale exceeding one million structures by partitioning the region into tiles, processing each tile to generate and index patch embeddings, and supporting interactive queries over the full indexed collection. The partitioned indexing approach enables parallel processing and distributed storage.

In another example configuration, a multi-modal query comprising both an image patch and a textual descriptor is embedded into the shared embedding space and used to retrieve matching structures that satisfy both visual similarity and textual constraint criteria.

These configurations are illustrative and not limiting.

### Non-Limiting Language

It will be appreciated by those skilled in the art that the embodiments described herein may be implemented in hardware, software, firmware, or any combination thereof. Where described as software, the embodiments may be stored in non-transitory computer-readable media as instructions executable by one or more processors.

It will be further appreciated by those skilled in the art that the functions described herein may be performed in an order different from that described, and that steps may be omitted, combined, or repeated in various embodiments, without departing from the scope of the claims.

The foregoing detailed description is illustrative and not restrictive. The scope of the invention is defined by the claims, and all equivalents are intended to be encompassed thereby.

1. A system for image-based analysis of built-environment structures at multiple geographic scales, the system comprising:
at least one processor; and
at least one memory storing instructions that, when executed by the at least one processor, cause the system to:
receive one or more images depicting a geographic region containing one or more built-environment structures;
extract, from the one or more images, a plurality of image patches at a plurality of spatial scales, wherein a first spatial scale of the plurality of spatial scales captures contextual features of at least one built-environment structure and a second spatial scale of the plurality of spatial scales captures localized surface features of the at least one built-environment structure;
generate, for each image patch of the plurality of image patches, a respective patch embedding via a domain-specific embedding model that has been trained using at least one of semi-supervised learning or unsupervised learning on training images of built-environment structures;
receive a query and generate a corresponding query embedding in an embedding space shared with the patch embeddings;
compute, for each patch embedding, a similarity score between the patch embedding and the query embedding using a similarity metric; and
aggregate the similarity scores across the plurality of spatial scales to produce a composite similarity result for the at least one built-environment structure.

2. The system of claim 1, wherein the instructions further cause the system to extract overlapping patches at at least one spatial scale of the plurality of spatial scales, wherein adjacent patches share a configurable percentage of spatial extent.

3. The system of claim 1, wherein the instructions further cause the system to preprocess the one or more images using at least one of superresolution or denoising prior to extracting the plurality of image patches.

4. The system of claim 1, wherein the domain-specific embedding model has been trained using a contrastive learning objective in which the domain-specific embedding model is trained to produce similar embeddings for semantically similar patches and dissimilar embeddings for semantically different patches.

5. The system of claim 1, wherein the domain-specific embedding model has been trained using a reconstruction-based learning objective in which the domain-specific embedding model is trained to reconstruct masked or corrupted portions of input patches.

6. The system of claim 1, wherein the query comprises a textual descriptor, and wherein the instructions further cause the system to generate the query embedding by mapping the textual descriptor into the embedding space shared with the patch embeddings via a multi-modal embedding mechanism.

7. The system of claim 1, wherein the instructions further cause the system to:
analyze the one or more images at a first image resolution using patches at a coarse spatial scale to compute coarse similarity scores and to identify one or more candidate regions based on the coarse similarity scores exceeding a configurable threshold; and
selectively retrieve imagery at a second image resolution higher than the first image resolution for the one or more candidate regions and extract patches at a finer spatial scale from the selectively retrieved imagery.

8. The system of claim 1, wherein precomputed patch embeddings for a plurality of built-environment structures across one or more geographic regions are stored in a searchable embedding index, and wherein computing the similarity scores comprises querying the searchable embedding index.

9. The system of claim 1, wherein the instructions further cause the system to:
receive feedback from a user indicating whether one or more returned results are correct or incorrect; and
incorporate the feedback as a training signal for updating the domain-specific embedding model.

10. The system of claim 1, wherein aggregating the similarity scores comprises computing a weighted combination of scale-specific similarity scores, wherein weighting parameters for the weighted combination are configurable.

11. A computer-implemented method for identifying or classifying features of built-environment structures across one or more geographic regions, the method comprising:
receiving, by at least one processor, one or more images depicting a geographic region containing one or more built-environment structures;
extracting, by the at least one processor, a plurality of image patches from the one or more images at a plurality of spatial scales, wherein a first spatial scale of the plurality of spatial scales captures contextual features of at least one built-environment structure of the one or more built-environment structures and a second spatial scale of the plurality of spatial scales captures localized surface features of the at least one built-environment structure;
generating, by the at least one processor, for each image patch of the plurality of image patches, a respective patch embedding via a domain-specific embedding model trained using at least one of semi-supervised learning or unsupervised learning on training images of built-environment structures;
receiving a query and generating, by the at least one processor, a corresponding query embedding in an embedding space shared with the patch embeddings;
computing, by the at least one processor, similarity scores between the query embedding and the patch embeddings using a similarity metric; and
aggregating, by the at least one processor, the similarity scores across the plurality of spatial scales to produce a composite similarity result for the at least one built-environment structure.

12. The method of claim 11, further comprising extracting overlapping patches at at least one spatial scale of the plurality of spatial scales, wherein adjacent patches share a configurable percentage of spatial extent.

13. The method of claim 11, further comprising:
analyzing the one or more images at a first image resolution using patches at a coarse spatial scale of the plurality of spatial scales to identify one or more candidate regions based on similarity scores at the coarse spatial scale exceeding a configurable threshold; and
selectively retrieving imagery at a second image resolution higher than the first image resolution for the one or more candidate regions and extracting patches at a finer spatial scale of the plurality of spatial scales from the selectively retrieved imagery to reduce bandwidth consumption while refining the composite similarity result.

14. The method of claim 11, further comprising applying a clustering algorithm to the patch embeddings to identify one or more cohorts of built-environment structures sharing one or more characteristics.

15. The method of claim 11, further comprising deriving, from one or more patch embeddings, a structured attribute representation comprising estimated values for one or more physical characteristics of a depicted built-environment structure, the one or more physical characteristics including at least one of material type, surface condition, color, or structural style.

16. The method of claim 11, wherein the query comprises a ground-level photograph of a built-environment structure surface, and wherein the query embedding generated from the ground-level photograph is compared against patch embeddings derived from aerial or satellite imagery.

17. The method of claim 11, further comprising outputting, based on the composite similarity result, at least one of: a ranked list of matching properties or addresses, a match score for a specified address, or a map view highlighting one or more matching regions.

18. A non-transitory computer-readable medium storing instructions that, when executed by at least one processor, cause the at least one processor to perform operations comprising:
receiving one or more images depicting a geographic region containing one or more built-environment structures, wherein the one or more built-environment structures include one or more roofs;
extracting a plurality of image patches from the one or more images at a plurality of spatial scales, wherein a first spatial scale of the plurality of spatial scales captures roof geometry of at least one roof of the one or more roofs and a second spatial scale of the plurality of spatial scales captures roofing surface material texture of the at least one roof;
generating, for each image patch of the plurality of image patches, a respective patch embedding via a domain-specific embedding model trained using at least one of semi-supervised learning or unsupervised learning on training images depicting roofs;
receiving a query and generating a corresponding query embedding in an embedding space shared with the patch embeddings;
computing similarity scores between the query embedding and the patch embeddings using a similarity metric; and
aggregating the similarity scores across the plurality of spatial scales to produce a composite similarity result indicative of roof material or condition.

19. The non-transitory computer-readable medium of claim 18, wherein the roofing surface material texture captured at the second spatial scale includes one or more of asphalt shingle texture, metal panel texture, membrane surface texture, clay tile texture, or wood shake texture, and wherein the composite similarity result is indicative of at least one of material type, surface condition, estimated age, or damage state.

20. The non-transitory computer-readable medium of claim 18, wherein the operations further comprise deploying a compressed version of the domain-specific embedding model on an edge device, the compressed version produced using at least one of knowledge distillation, weight pruning, or quantization.
